(19) United States
(12) Patent Application Publication
(10) Pub. No.: US 2014/0044168 A1
(43) Pub. Date: Feb. 13, 2014

(54) DEVICE AND METHOD FOR SCALABLE CODING OF VIDEO INFORMATION

(71) Applicant: QUALCOMM Incorporated, San Diego, CA (US)

(72) Inventors: Vadim SEREGIN, San Diego, CA (US); Krishnakanth RAPAKA, San Diego, CA (US)

(73) Assignee: QUALCOMM Incorporated, San Diego, CA (US)

(21) Appl. No.: 13/963,673

(22) Filed: Aug. 9, 2013

Related U.S. Application Data
(60) Provisional application No. 61/682,723, filed on Aug. 13, 2012.
(60) Provisional application No. 61/707,862, filed on Sep. 28, 2012.

(51) Int. Cl. H04N 7/36

(52) U.S. Cl. CPC H04N 19/00575
USPC 375/240.12

(57) ABSTRACT

An apparatus for coding video data according to certain aspects includes a memory unit and a processor in communication with the memory unit. The memory unit is configured to store video data associated with a base layer and a corresponding enhancement layer. The processor is in communication with the memory, and in a case that the video data comprises a particular mode flag, the processor determines (e.g., predicts) an enhancement layer block in the enhancement layer of the video data based at least in part on a co-located block in the base layer of video data while assuming a residual associated with the enhancement layer block in the enhancement layer (the co-located block in the base layer being a predictor for the enhancement layer block) is equal to zero and without transmitting or receiving the residual or transform coefficients, coded block flags or a transform depth associated with the enhancement layer block. The co-located block in the base layer is located at a position in the base layer corresponding to a position of the enhancement layer block in the enhancement layer. The position on the base layer block can be adjusted according to the ratio of the base and enhancement frame resolutions. The processor may encode or decode the video data.

### CROSS-REFERENCE TO RELATED APPLICATIONS

This application claims priority to U.S. Provisional No. 61/682,723, filed Aug. 13, 2012, and to U.S. Provisional No. 61/707,862, filed Sep. 28, 2012, each of which is hereby incorporated by reference in its entirety.

### TECHNICAL FIELD

This disclosure relates to HEVC scalable video coding (SVC) extension.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implemented such video coding techniques.

Video compression techniques perform spatial (intra-picture) prediction and/or temporal (inter-picture) prediction to reduce or remove redundancy inherent in video sequences. For block-based video coding, a video slice (e.g., a video frame, a portion of a video frame, etc.) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy encoding may be applied to achieve even more compression.

Some block-based video coding and compression makes use of scalable techniques. Scalable video coding (SVC) refers to video coding in which a base layer (BL) and one or more scalable enhancement layers (EL) are used. For SVC, a base layer typically carries video data with a base level of quality. One or more enhancement layers carry additional video data to support higher spatial, temporal and/or SNR levels. In some cases, the base layer may be transmitted in a manner that is more reliable than the transmission of enhancement layers.

In SVC, IntraBL or TextureBL mode is a mode when a reconstructed base layer is used as a prediction for an enhanced layer. IntraBL mode is currently signaled as a first mode, followed by two subsequent modes: InterSkip and normal Intra/Inter modes.

Although the IntraBL mode is frequently used, there is no skip mode associated with the IntraBL mode. Thus, unnecessary calculations may be performed and/or unnecessary data may be transmitted and received when the IntraBL mode is used.

Thus, there is a need for a method of video coding with improved coding efficiency and/or reduced computational complexity.

### SUMMARY

The systems, methods and devices of this disclosure each have several innovative aspects, no single one of which is solely responsible for the desirable attributes disclosed herein.

In one embodiment, an apparatus configured to code video data includes a memory unit and a processor in communication with the memory unit. The memory unit is configured to store the video data comprising a base layer and a corresponding enhancement layer. The processor is in communication with the memory and is configured to determine (e.g., predict) an enhancement layer block in the enhancement layer of the video data based at least in part on a co-located block in the base layer of the video data while assuming a residual associated with the enhancement layer block (the co-located block in the base layer being a predictor for the enhancement layer block) is equal to zero and without transmitting or receiving transform coefficients, coded block flags or a transform depth associated with the enhancement layer block, in a case that the video data comprises a particular mode flag. In one embodiment, the particular mode flag may be a skip mode indicator associated with an IntraBL mode (e.g. indicating an “IntraBLSkip” mode). In another embodiment, the particular mode flag may be a no_residual_data_flag indicating whether the residual associated with the enhancement layer block is equal to zero. In all embodiments, the co-located block in the base layer may be located at a position in the base layer corresponding to a position of the enhancement layer block in the enhancement layer. In addition, in all embodiments, the co-located block in the base layer may be located at a position in a scaled version (e.g., upsampled, downsampled) of the base layer, e.g., if the base layer and enhancement layer have different scales or frame resolutions. The processor may encode or decode the video data.

The processor may be further configured to insert the IntraBLSkip mode as a first signaled mode in a mode list associated with the enhancement layer block. The IntraBLSkip mode indicator may be signaled using at least one of a partition unit (PU) level, a coding unit (CU) level, a group of coding units level, a slice level, a frame level, a largest coding unit (LCU) level and a color component level. The processor may be further configured to determine the enhancement layer block based at least in part upon an IntraBL mode indicator. The processor may be further configured to first determine whether the video information comprises the IntraBLSkip mode indicator and subsequently determine whether the video information comprises the IntraBL mode indicator. The processor may be further configured to first determine whether the video information comprises the IntraBL mode indicator and subsequently determine whether the video information comprises the IntraBLSkip mode indicator. In some embodiments, the IntraBL mode indicator is coded with InterSkip mode indicator contexts. In some embodiments, the IntraBLSkip mode indicator is coded with contexts solely related to the IntraBLSkip mode, with IntraBL mode indicator contexts or with InterSkip mode indicator contexts.

In yet another embodiment, a method of coding video data includes receiving information associated with a base layer and a corresponding enhancement layer; and determining an enhancement layer block in the enhancement layer of the video data based at least in part on a co-located block in the base layer of the video data while assuming a residual associated with the enhancement layer block (the co-located block in the base layer being a predictor for the enhancement layer block) is equal to zero and without transmitting or receiving coefficients, coded block flags or a transform depth associated with the enhancement layer block, in a case that the video data comprises a particular mode flag, wherein the co-located block in the base layer is located at a position in the base layer corresponding to a position of the enhancement layer block in the enhancement layer. In one embodiment, the particular mode flag may be a skip mode indicator associated with an IntraBL mode (e.g. indicating an “IntraBLSkip” mode). In another embodiment, the particular mode flag may be a no_residual_data_flag indicating whether the residual associated with the enhancement layer block is equal to zero. The position of the base layer block can be adjusted according to the ratio of the base and enhancement frame resolutions.

In one embodiment, the method also includes inserting the IntraBLSkip mode as a first signaled mode in a mode list associated with the enhancement layer block. In one embodiment, the method also includes signaling the IntraBLSkip mode indicator using at least one of a partition unit (PU) level, a coding unit (CU) level, a group of coding units, a slice level, a frame level, a largest coding unit (LCU) level and a color component level. In one embodiment, the method also includes determining the enhancement layer block based at least in part upon an IntraBL mode indicator. In one embodiment, the method also includes first determining whether the video data comprises the IntraBLSkip mode indicator and subsequently determining whether the video data comprises the IntraBL mode indicator. In one embodiment, the method also includes first determining whether the video data comprises the IntraBL mode indicator and subsequently determining whether the video data comprises the IntraBLSkip mode indicator. In one embodiment, the method also includes coding the IntraBL mode indicator with InterSkip mode indicator contexts. In one embodiment, the method also includes coding the IntraBLSkip mode indicator with contexts solely related to the IntraBLSkip mode. In one embodiment, the method also includes coding the IntraBLSkip mode indicator with IntraBL mode indicator contexts. In one embodiment, the method also includes coding the IntraBLSkip mode indicator with InterSkip mode indicator contexts.

In yet another embodiment, a non-transitory computer readable medium includes code that, when executed, causes an apparatus to: store video data associated with a base layer and a corresponding enhancement layer; and determine an enhancement layer block in the enhancement layer of the video data based at least in part on a co-located block in the base layer of the video data while assuming a residual associated with the enhancement layer block (the co-located block in the base layer being a predictor for the enhancement layer block) is equal to zero and without transmitting or receiving transform coefficients, coded block flags or a transform depth associated with the enhancement layer block, in a case that the video data comprises a particular mode flag, wherein the co-located block in the base layer is located at a position in the base layer corresponding to a position of the enhancement layer block in the enhancement layer. The position of the base layer block can be adjusted according to the ratio of the base and enhancement frame resolutions.

In yet another embodiment, a video coding device configured to code video data includes: means for storing the video data associated with a base layer and a corresponding enhancement layer; and means for determining an enhancement layer block in the enhancement layer of the video data based at least in part on a co-located block in the base layer of the video data while assuming a residual associated with the enhancement layer block (the co-located block in the base layer being a predictor for the enhancement layer block) is equal to zero and without transmitting or receiving transform coefficients, coded block flags or a transform depth associated with the co-located block in the base layer, in a case that the video data comprises a particular mode flag, wherein the co-located block in the base layer is located at a position in the base layer corresponding to a position of the enhancement layer block in the enhancement layer. The position of the base layer block can be adjusted according to the ratio of the base and enhancement frame resolutions.

### BRIEF DESCRIPTION OF DRAWINGS

FIG. 1 is a block diagram illustrating an example video encoding and decoding system that may utilize techniques in accordance with aspects described in this disclosure.

FIG. 2 is a block diagram illustrating an example of a video encoder that may implement techniques in accordance with aspects described in this disclosure.

FIG. 3 is a block diagram illustrating an example of a video decoder that may implement techniques in accordance with aspects described in this disclosure.

FIG. 4 is a flow chart illustrating a method for determining an enhancement layer block.

FIGS. 5 and 6 are flow charts illustrating methods for coding video information.

### DETAILED DESCRIPTION

The techniques described in this disclosure generally relate to scalable video coding (SVC) and 3D video coding. For example, the techniques may be related to, and used with or within, a High Efficiency Video Coding (HEVC) scalable video coding (SVC) extension. In an SVC extension, there could be multiple layers of video information. The layer at the very bottom level may serve as a base layer (BL), and the layer at the very top may serve as an enhanced layer (EL). The “enhanced layer” is sometimes referred to as an “enhancement layer,” and these terms may be used interchangeably. All layers in the middle may serve as either or both ELs or BLs. For example, a layer in the middle may be an EL for the layers below it, such as the base layer or any intervening enhancement layers, and at the same time serve as a BL for the enhancement layers above it.

In some examples of a SVC, IntraBL or TextureBL mode is a mode in which a reconstructed base layer is used as a prediction for an enhanced layer. IntraBL mode may be signaled as a first mode, followed by two subsequent modes: InterSkip and normal Intra/Inter modes. Although the IntraBL mode is frequently used, there is no skip mode associated with the IntraBL mode. Thus, unnecessary calculations may be performed and/or unnecessary data may be transmitted and received when the IntraBL mode is used.

By reducing or minimizing such unnecessary calculations and transmissions of video information, the techniques described in this disclosure may improve coding efficiency and/or reduce computational complexity associated with a method of coding video data.

For purposes of illustration only, the techniques described in the disclosure are described with examples including only two layers (e.g., lower level layer such as the base layer, and a higher level layer such as the enhanced layer, etc.). It should be understood that the examples described in this disclosure can be extended to examples with multiple base layers and enhancement layers as well.

### Video Coding Standards

A digital image, such as a video image, a TV image, a still image or an image generated by a video recorder or a computer, may consist of pixels arranged in horizontal and vertical lines. The number of pixels in a single image is typically in the tens of thousands. Each pixel typically contains luminance and chrominance information. Without compression, the quantity of information to be conveyed from an image encoder to an image decoder is so enormous that it renders real-time image transmission impossible. To reduce the amount of information to be transmitted, a number of different compression methods, such as JPEG, MPEG and H.263 standards, have been developed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). A recent draft of HEVC is available from http://phenix.it-sudparis.eu/jct/doc_end_user/documents/12_Geneva/wg11/JCTVC-L1003-v34.zip, as of May 21, 2013, which is incorporated by reference in its entirety. The full citation for the HEVC Draft 10 is document JCTVC-L1003, Bross et al., “High Efficiency Video Coding (HEVC) Text Specification Draft 10,” Joint Collaborative Team on Video Coding (JCT-VC) of ITU-T SG16 WP3 and ISO/IEC JTC1/SC29/WG11, 12th Meeting: Geneva, Switzerland, Jan. 14, 2013 to Jan. 23, 2013.

Scalable video coding (SVC) may be used to provide quality (also referred to as signal-to-noise (SNR)) scalability, spatial scalability and/or temporal scalability. For example, in one embodiment, a reference layer (e.g., a base layer) includes video information sufficient to display a video at a first quality level and the enhancement layer includes additional video information relative to the reference layer such that the reference layer and the enhancement layer together include video information sufficient to display the video at a second quality level higher than the first level (e.g., less noise, greater resolution, better frame rate, etc.). An enhanced layer may have different spatial resolution than base layer. For example, the spatial aspect ratio between EL and BL can be 1.0, 1.5, 2.0 or other different ratios. In other words, the spatial aspect of the EL may equal 1.0, 1.5, or 2.0 times the spatial aspect of the BL. In some examples, the scaling factor of the EL may be greater than the BL. For example, a size of pictures in the EL may be greater than a size of pictures in the BL. In this way, it may be possible, although not a limitation, that the spatial resolution of the EL is larger than the spatial resolution of the BL.

In SVC extension for H.264, prediction of a current block may be performed using the different layers that are provided for SVC. Such prediction may be referred to as inter-layer prediction. Inter-layer prediction methods may be utilized in SVC in order to reduce inter-layer redundancy. Some examples of inter-layer prediction may include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion of the base layer to predict motion in the enhancement layer. Inter-layer residual prediction uses the residue of the base layer to predict the residue of the enhancement layer.

In inter-layer residual prediction, the residue of the base layer may be used to predict the current block in the enhancement layer. The residue may be defined as the difference between the temporal prediction for a video unit and the source video unit. In residual prediction, the residue of the enhancement layer is also considered in predicting the current block. For example, the current block may be reconstructed using the residue from the enhancement layer, the temporal prediction from the enhancement layer, and the residue from the base layer. The current block may be reconstructed according to the following equation:

Îₑ=rₑ+Pₑ+r_{b} (1)

where Îₑ denotes the reconstruction of the current block, rₑ denotes the residue from the enhancement layer, Pₑ denotes the temporal prediction from the enhancement layer, and r_{b} denotes the residue prediction from the base layer.

In order to use inter-layer residual prediction for a macroblock (MB) in the enhancement layer, the co-located macroblock in the base layer should be an inter MB, and the residue of the co-located base layer macroblock may be upsampled according to the spatial resolution ratio of the enhancement layer (e.g., because the layers in SVC may have different spatial resolutions). In inter-layer residual prediction, the difference between the residue of the enhancement layer and the residue of the upsampled base layer may be coded in the bitstream. The residue of the base layer may be normalized based on the ratio between quantization steps of base and enhancement layers.

SVC extension to H.264 provides single-loop decoding for motion compensation in order to maintain low complexity for the decoder. In general, motion compensation is performed by adding the temporal prediction and the residue for the current block as follows:

Î=r+P (2)

where Î denotes the current frame, r denotes the residue, and P denotes the temporal prediction. In single-loop decoding, each supported layer in SVC can be decoded with a single motion compensation loop. In order to achieve this, all blocks that are used to inter-layer intra predict higher blocks are coded using constrained intra-prediction. In constrained intra prediction, intra mode MBs are intra-coded without referring to any samples from neighboring inter-coded MBs. On the other hand, HEVC allows multi-loop decoding for SVC, in which an SVC layer may be decoded using multiple motion compensation loops. For example, the base layer is fully decoded first, and then the enhancement layer is decoded.

Residual prediction formulated in Equation (1) may be an efficient technique in H.264 SVC extension. However, its performance can be further improved in HEVC SVC extension, especially when multi-loop decoding is used in HEVC SVC extension.

In the case of multi-loop decoding, difference domain motion compensation may be used in place of residual prediction. In SVC, an enhancement layer may be coded using pixel domain coding or difference domain coding. In pixel domain coding, the input pixels for an enhancement layer may be coded, as for a non-SVC HEVC layer. On the other hand, in difference domain coding, difference values for an enhancement layer may be coded. The difference values may be the difference between the input pixels for the enhancement layer and the corresponding scaled base layer reconstructed pixels. Such difference values may be used in motion compensation for difference domain motion compensation.

For inter coding using difference domain, the current predicted block is determined based on the difference values between the corresponding predicted block samples in the enhancement layer reference picture and the corresponding predicted block samples in the scaled base layer reference picture. The difference values may be referred to as the difference predicted block. The co-located base layer reconstructed samples are added to the difference predicted block in order to obtain enhancement layer reconstructed samples.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description.

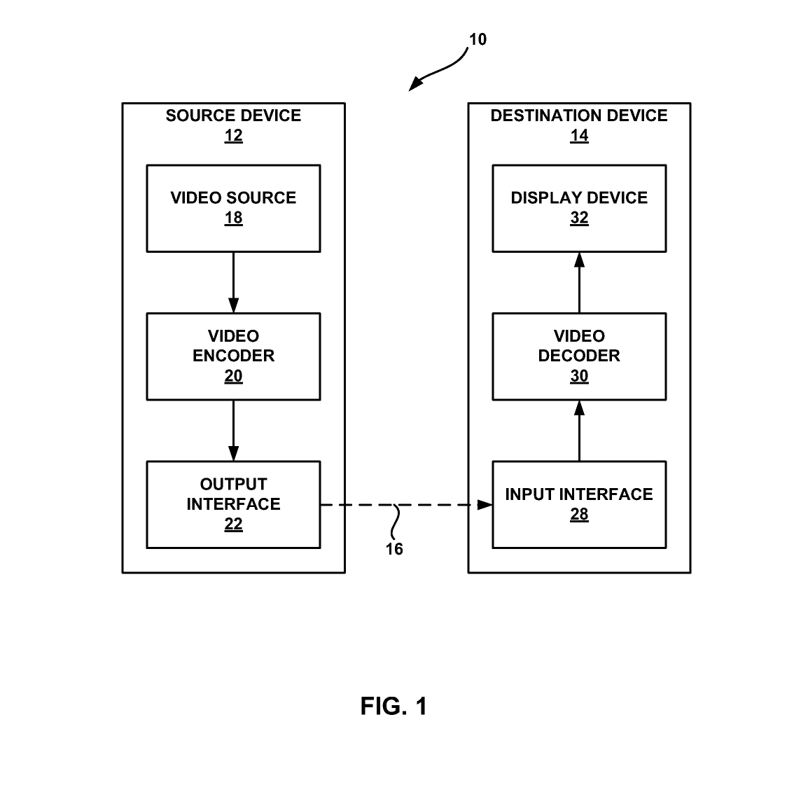

FIG. 1 is a block diagram that illustrates an example video coding system 10 that may utilize techniques in accordance with aspects described in this disclosure. As used described herein, the term “video coder” refers generically to both video encoders and video decoders. In this disclosure, the terms “video coding” or “coding” may refer generically to video encoding and video decoding.

As shown in FIG. 1, video coding system 10 includes a source device 12 and a destination device 14. Source device 12 generates encoded video data. Destination device 14 may decode the encoded video data generated by source device 12. Source device 12 and destination device 14 may comprise a wide range of devices, including desktop computers, notebook (e.g., laptop, etc.) computers, tablet computers, set-top boxes, telephone handsets such as so-called “smart” phones, so-called “smart” pads, televisions, cameras, display devices, digital media players, video gaming consoles, in-car computers, or the like. In some examples, source device 12 and destination device 14 may be equipped for wireless communication.

Destination device 14 may receive encoded video data from source device 12 via a channel 16. Channel 16 may comprise any type of medium or device capable of moving the encoded video data from source device 12 to destination device 14. In one example, channel 16 may comprise a communication medium that enables source device 12 to transmit encoded video data directly to destination device 14 in real-time. In this example, source device 12 may modulate the encoded video data according to a communication standard, such as a wireless communication protocol, and may transmit the modulated video data to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or other equipment that facilitates communication from source device 12 to destination device 14.

In another example, channel 16 may correspond to a storage medium that stores the encoded video data generated by source device 12. In this example, destination device 14 may access the storage medium via disk access or card access. The storage medium may include a variety of locally accessed data storage media such as Blu-ray discs, DVDs, CD-ROMs, flash memory, or other suitable digital storage media for storing encoded video data. In a further example, channel 16 may include a file server or another intermediate storage device that stores the encoded video generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website, etc.), FTP servers, network attached storage (NAS) devices, and local disk drives. Destination device 14 may access the encoded video data through any standard data connection, including an Internet connection. Example types of data connections may include wireless channels (e.g., Wi-Fi connections, etc.), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet (e.g., dynamic adaptive streaming over HTTP (DASH), etc.), encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1, source device 12 includes a video source 18, video encoder 20, and an output interface 22. In some cases, output interface 22 may include a modulator/demodulator (modem) and/or a transmitter. In source device 12, video source 18 may include a source such as a video capture device, e.g., a video camera, a video archive containing previously captured video data, a video feed interface to receive video data from a video content provider, and/or a computer graphics system for generating video data, or a combination of such sources.

Video encoder 20 may be configured to encode the captured, pre-captured, or computer-generated video data. The encoded video data may be transmitted directly to destination device 14 via output interface 22 of source device 12. The encoded video data may also be stored onto a storage medium or a file server for later access by destination device 14 for decoding and/or playback.

In the example of FIG. 1, destination device 14 includes an input interface 28, a video decoder 30, and a display device 32. In some cases, input interface 28 may include a receiver and/or a modem. Input interface 28 of destination device 14 receives encoded video data over channel 16. The encoded video data may include a variety of syntax elements generated by video encoder 20 that represent the video data. The syntax elements may describe characteristics and/or processing of blocks and other coded units, e.g., groups of pictures (GOPs). Such syntax elements may be included with the encoded video data transmitted on a communication medium, stored on a storage medium, or stored a file server.

Display device 32 may be integrated with or may be external to destination device 14. In some examples, destination device 14 may include an integrated display device and may also be configured to interface with an external display device. In other examples, destination device 14 may be a display device. In general, display device 32 displays the decoded video data to a user. Display device 32 may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to a HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in the example of FIG. 1, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Again, FIG. 1 is merely an example and the techniques of this disclosure may apply to video coding settings (e.g., video encoding or video decoding) that do not necessarily include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, hardware, or any combinations thereof. When the techniques are implemented partially in software, a device may store instructions for the software in a suitable, non-transitory computer-readable storage medium and may execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular, etc.) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision, etc.), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be co-located with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up,” “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks may not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization is a broad term intended to have its broadest ordinary meaning. In one embodiment, quantization refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

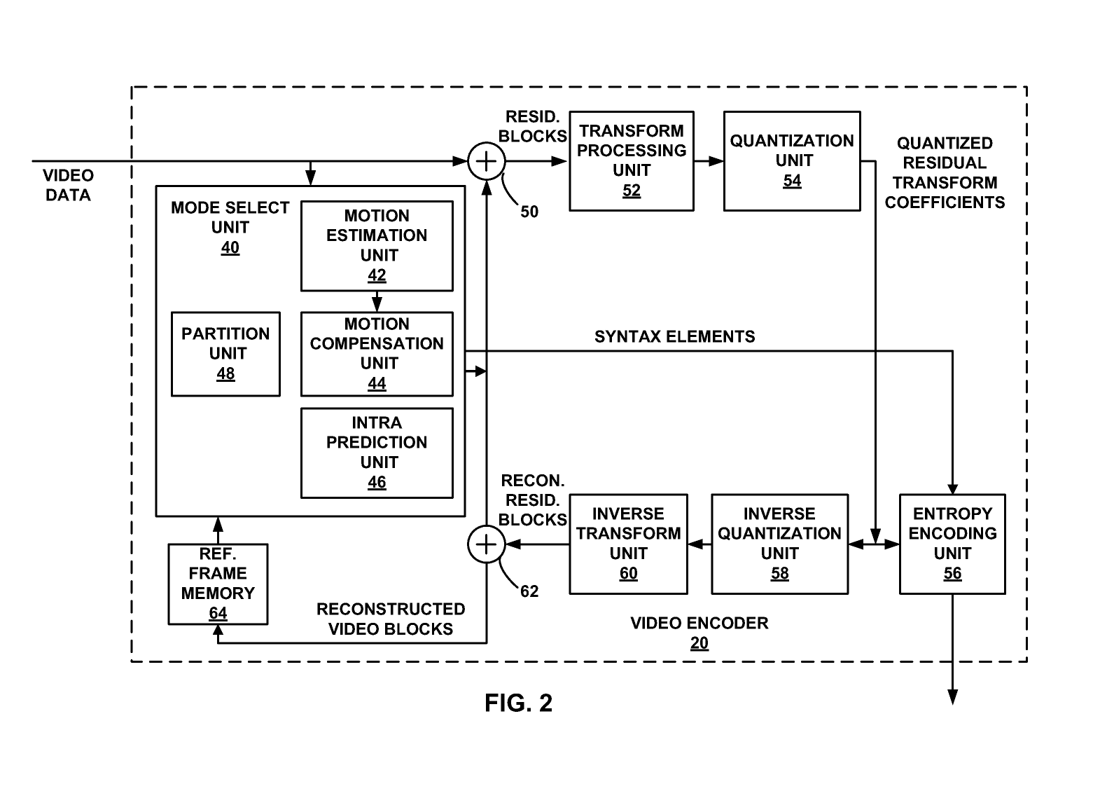

FIG. 2 is a block diagram illustrating an example of a video encoder that may implement techniques in accordance with aspects described in this disclosure. Video encoder 20 may be configured to perform any or all of the techniques of this disclosure. As one example, mode select unit 40 may be configured to perform any or all of the techniques described in this disclosure. However, aspects of this disclosure are not so limited. In some examples, the techniques described in this disclosure may be shared among the various components of video encoder 20. In some examples, in addition to or instead of, a processor (not shown) may be configured to perform any or all of the techniques described in this disclosure.

Video encoder 20 may perform intra- and inter-coding of video blocks within video slices. Intra coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization, etc.). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provide the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identifies one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice. In one embodiment, an IntraBLSkip mode flag or a no_residual_data_flag, which are further discussed infra, may be generated, transmitted and/or signaled by the mode select unit 40 for use by video decoder 30. In one embodiment, such mode flag may be signaled upon determining that the transform coefficients generated by the transform processing unit 52 and the quantization unit 54 are indeed zero. In another embodiment, the transform coefficients may be assumed or forced to be zero, and if the corresponding rate-distortion characteristics (e.g. calculated by the intra-prediction unit 46) are acceptable, the particular mode flag (e.g. IntraBLSkip mode flag or no_residual_data_flag) may be signaled.

Intra-prediction unit 46 may intra-predict or calculate a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

However, in one embodiment, the residual of the current block may be assumed (or determined) to be zero, and the application of the transform and the quantization of the transform coefficients may be omitted. In such case, the residual associated with the current block or transform coefficients, coded block flags or transform depths may not be transmitted.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

In another embodiment, not shown, a filter module may receive the reconstructed video block from the summer 62. The filter module may perform a deblocking operation to reduce blocking artifacts in the video block associated with the CU. After performing the one or more deblocking operations, the filter module may store the reconstructed video block of the CU in decoded picture buffer. The motion estimation unit 42 and the motion compensation unit 44 may use a reference picture that contains the reconstructed video block to perform inter prediction on PUs of subsequent pictures. In addition, the intra prediction unit 46 may use reconstructed video blocks in the decoded picture buffer to perform intra prediction on other PUs in the same picture as the CU. Thus, after the filter module applies a deblocking filter to the samples associated with an edge, a predicted video block may be generated based at least in part on the samples associated with the edge. The video encoder 20 may output a bitstream that includes one or more syntax elements whose values are based at least in part on the predicted video block.

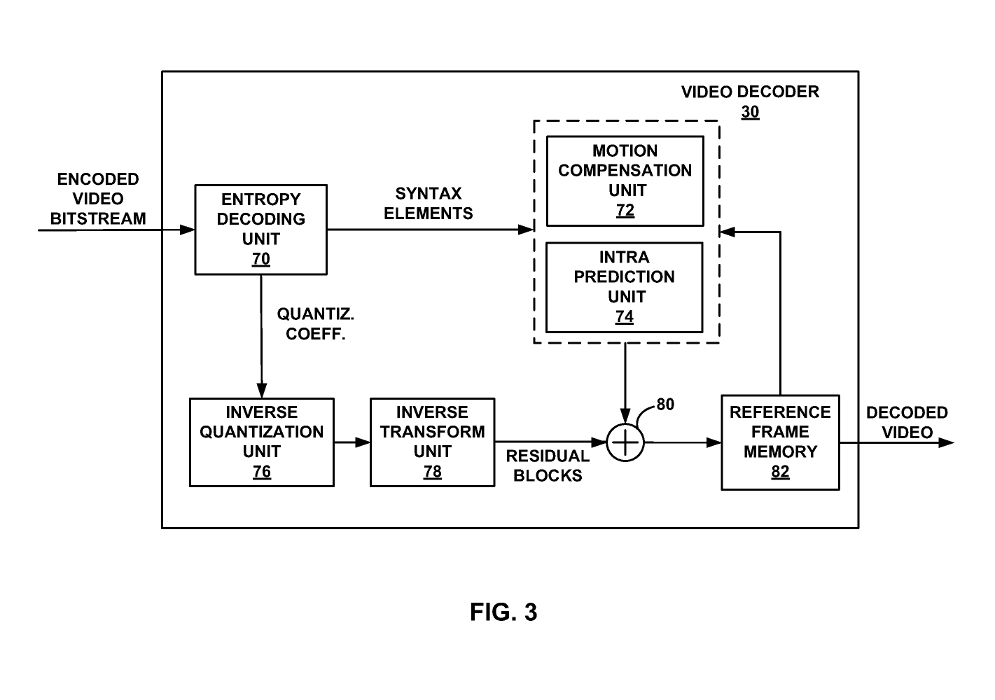

FIG. 3 is a block diagram illustrating an example of a video decoder that may implement techniques in accordance with aspects described in this disclosure. Video decoder 30 may be configured to perform any or all of the techniques of this disclosure. As one example, motion compensation unit 72 and/or intra prediction unit 74 may be configured to perform any or all of the techniques described in this disclosure. However, aspects of this disclosure are not so limited. In some examples, the techniques described in this disclosure may be shared among the various components of video decoder 30. In some examples, in addition to or instead of, a processor (not shown) may be configured to perform any or all of the techniques described in this disclosure.

In the example of FIG. 3, video decoder 30 includes an entropy decoding unit 70, motion compensation unit 72, intra prediction unit 74, inverse quantization unit 76, inverse transformation unit 78, reference frame memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (e.g., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice. In one embodiment, motion compensation unit 72, upon determining that the received syntax elements comprise a particular mode flag (e.g. a skip mode indicator), determines (e.g. predicts) the current video block while assuming the residual associated with the current video block is equal to zero. In another embodiment, the determination of whether the received video bitstream comprises such particular mode flag may be performed by a unit other than motion compensation unit 72 (e.g. entropy decoding unit 70 or another unit not shown in FIG. 3 and disposed between entropy decoding unit 70 and motion compensation unit 72). In a case that the received syntax elements comprise the particular mode flag, transform coefficients, coded block flags and/or a transform depth associated with the current video block may not be included in the encoded video bitstream received by decoder 30, and thus the inverse quantization and inverse transformation process illustrated in FIG. 3 may be omitted in determining such current video block.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, e.g., de-quantizes, the quantized transform coefficients provided in the bitstream and decoded by entropy decoding unit 70. The inverse quantization process may include use of a quantization parameter QPY calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference frame memory 82 also stores decoded video for later presentation on a display device, such as display device 32 of FIG. 1.

In another embodiment, not shown, after the summer 80 reconstructs the video block of the CU, a filter module may perform a deblocking operation to reduce blocking artifacts associated with the CU. After the filter module performs a deblocking operation to reduce blocking artifacts associated with the CU, the video decoder 30 may store the video block of the CU in a decoded picture buffer. The decoded picture buffer may provide reference pictures for subsequent motion compensation, intra prediction, and presentation on a display device, such as display device 32 of FIG. 1. For instance, the video decoder 30 may perform, based on the video blocks in the decoded picture buffer, intra prediction or inter prediction operations on PUs of other CUs.

### Video Encoder and Decoder

In a typical video encoder, the frame of the original video sequence is partitioned into rectangular regions or blocks, which are encoded in Intra-mode (I-mode) or Inter-mode (P-mode). The blocks are coded using some kind of transform coding, such as DCT coding. However, pure transform-based coding may only reduce the inter-pixel correlation within a particular block, without considering the inter-block correlation of pixels, and may still produce high bit-rates for transmission. Current digital image coding standards may also exploit certain methods that reduce the correlation of pixel values between blocks.

In general, blocks encoded in P-mode are predicted from one of the previously coded and transmitted frames. The prediction information of a block may be represented by a two-dimensional (2D) motion vector. For the blocks encoded in I-mode, the predicted block is formed using spatial prediction from already encoded neighboring blocks within the same frame. The prediction error (e.g., the difference between the block being encoded and the predicted block) may be represented as a set of weighted basis functions of some discrete transform. The prediction error may also be referred to as residual data. The transform is typically performed on an 8×8 or 4×4 block basis. The weights (e.g., transform coefficients) are subsequently quantized. Quantization introduces loss of information and, therefore, quantized coefficients have lower precision than the originals.

Quantized transform coefficients, together with motion vectors and some control information, may form a complete coded sequence representation and are referred to as syntax elements. Prior to transmission from the encoder to the decoder, all syntax elements may be entropy encoded so as to further reduce the number of bits needed for their representation.

In the decoder, the block in the current frame may be obtained by first constructing the block's prediction in the same manner as in the encoder and by adding to the prediction the compressed prediction error. The compressed prediction error may be found by weighting the transform basis functions using the quantized coefficients. The difference between the reconstructed frame and the original frame may be called reconstruction error.

In H.264/AVC, a video frame or slice is partitioned into square blocks of size 16×16 for encoding and decoding. Such blocks are called macroblocks. In the current high efficiency video coding (HEVC), a video frame or slice is partitioned into square blocks of variable sizes for encoding and decoding. Such blocks may be called coding units or CUs in HEVC. For example, the size of a CU may be 64×64, 32×32, 16×16 or 8×8. Unlike a macroblock, a larger size CU can be split into a number of smaller size CUs. A non-split CU and a macroblock are similar to each other in terms of their concept and functionality.

Once a macroblock or a non-split CU is determined, the block can be further split into a number of partitions for prediction. Such a partition may also be referred as prediction unit or PU in HEVC.

### Scalable Video Coding (SVC)

In SVC, video information may be provided as multiple layers. The layer at the very bottom level is referred to as a base layer (BL) and the layer at the very top level can be referred to as an enhancement layer (EL). All the layers in the middle can serve as both EL and BL. For example, a layer in the middle can be an EL for the layers below it, and at the same time as a BL for the layers above it. For simplicity of description, we assume that there are two layers, a BL and an EL, although all the devices and methods described herein are applicable to embodiments utilizing more than two layers.

In SVC, IntraBL or TextureBL mode is a mode when a reconstructed base layer is used as a prediction for an enhanced layer. For example, an enhancement layer block in the enhancement layer is predicted using reconstructed pixels of a base layer block in the base layer.

IntraBL mode is currently signaled as a first mode, followed by two subsequent modes: InterSkip and normal Intra/Inter modes. The IntraBL mode is frequently used to code video information. However, in some situations, there may not be a skip mode available for the IntraBL mode. The following embodiments address such situations.

### IntraBL Skip Mode

In one implementation, a new IntraBLSkip mode (e.g. a skip mode associated with the IntraBL mode) is provided. In this mode, a reconstructed base layer block is used as a prediction layer for determining (e.g. predicting) a current block in the enhancement layer. The residual information associated with the current block in the enhancement layer is assumed to be zero, and there is no need to transmit coefficients, coded block flags and transform depth. This new IntraBLSkip mode is similar to InterSkip mode in HEVC and H.264/AVC standards. In one embodiment, the IntraBLSkip mode flag is a 1-bit signal. In another embodiment, the IntraBLSkip mode flag may consist of multiple bits.

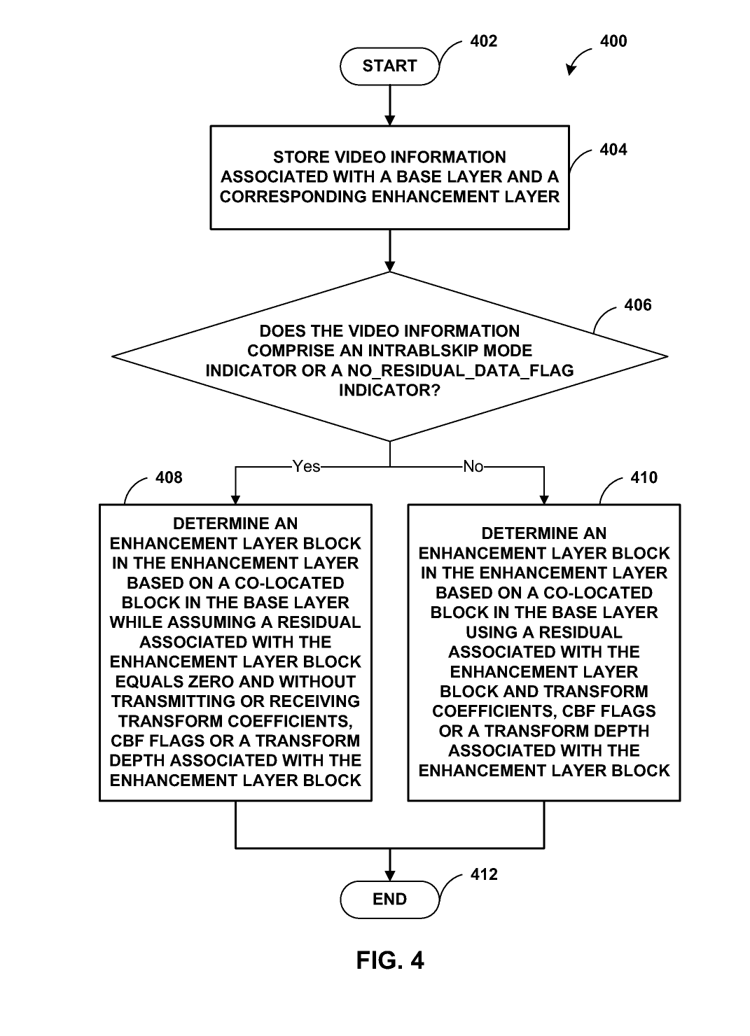

One embodiment of a method of coding video information in an IntraBLSkip mode is illustrated in FIG. 4. The method 400 begins at block 402. At block 404, video information associated with a base layer and a corresponding enhancement layer is stored. For example, the information may be stored in a memory, including any of the memory devices described herein.

At block 406, it is determined whether the video information includes a particular mode flag (e.g., a predetermined mode flag such as IntraBLSkip mode indicator or a no_residual_data_flag indicator, etc.). As discussed in connection with FIGS. 2 and 3, such determination may be made by, for example, the mode select unit 40 of the encoder 20 of FIG. 2 and/or the motion compensation unit 72 of the decoder 30 of FIG. 3.

If it is determined at block 406 that the video information includes the particular mode flag, an enhancement layer block in the enhancement layer is determined or predicted at block 408. The term “determined” is a broad term intended to have its ordinary meaning. In some embodiments, as used herein, “determined” may refer to a process of predicting a value or values, such as a value of a video unit. The block may be determined or predicted based on a co-located block in the base layer of the video information. Residual information associated with the enhancement layer block is assumed to be zero. In addition, transform coefficients, coded block flags and transform depths are not transmitted.

On the other hand, if it is determined at block 406 that the video information does not include the particular mode flag (e.g., absence of a predetermined mode flag such as IntraBLSkip mode indicator or no_residual_data_flag indicator), an enhancement layer block in the enhancement layer is determined or predicted at block 410. At block 410, the enhancement layer block is determined using a residual associated with the enhancement layer block and transform coefficients, coded block flags and/or transform depths associated with the enhancement layer block. From blocks 408 and 410 the method 400 continues to block 412, where the method 400 ends.

The method 400 and the determination at block 408 can be performed when an IntraBLSkip mode indicator (e.g., a flag) is set, or when a no_residual_data_flag indicator is set, as discussed in greater detail below.

IntraBLSkip mode can be introduced for every partition unit (PU) in 2N×2N, 2N×N, N×2N, N×N and AMP modes. In one embodiment, IntraBLSkip mode can be applied only at a coding unit (“CU”) level. In this case, there is no need to signal a partition mode, since only the 2N×2N partition is used.

In one embodiment, a 2N×2N partition is used and all the description is valid for other partition modes without limitations. When using a 2N×2N partition, the IntraBLSkip mode can be indicated by an additional mode flag signaled at the PU or CU level. The position of this mode can be different relatively to other already existing modes. For example, new IntraBLSkip mode can be inserted as a first signaled mode. For example, in one embodiment, the order of the modes is:
1. IntraBLSkip
2. IntraBL
3. InterSkip or MergeSkip in HEVC
4. Normal Intra/Inter modes

In another embodiment, the order of the modes is:
1. IntraBLSkip
2. InterSkip or MergeSkip in HEVC
3. IntraBL
4. Normal Intra/Inter modes

Additionally, IntraBLSkip mode can indicate the group of IntraBL modes. For example, the InterBLSkip flag can be signaled as enabled for both IntraBLSkip and IntraBL modes. An IntraBL flag can be signaled to identify whether IntraBL mode is used. This can be represented by the following pseudo code.

```
IntraBLSkip_flag indicates whether IntraBLSkip or
IntraBL modes are applied.
IntraBL_flag indicates whether IntraBL mode is applied.
  IntraBLSkip_flag
  if( IntraBLSkip_flag )
  {
    IntraBL_flag
  }
  Else
  {
      InterSkip and normal intra/inter modes
  }
```

In another embodiment, an IntraBL_flag indicates whether IntraBLSkip or IntraBL modes are used, and an IntraBLSkip_flag indicates whether IntraBLSkip mode is used. It can be shown by the following pseudo code.

```
IntraBL_flag
if( IntraBL_flag )
{
  IntraBLSkip_flag
}
Else
{
    InterSkip and normal intra/inter modes
}
```

New CABAC contexts can be introduced to code IntraBLSkip_flag, or context model can be shared with already existing modes. For example, IntraBLSkip_flag can be coded with IntraBL_flag contexts together. In another example IntraBLSkip_flag can be coded with InterSkip mode context.

In another embodiment, the same context sharing approach can be applied for IntraBL_flag coding. For example, an IntraBL_flag can be coded with an InterSkip mode context model. As described above, the IntraBLSkip mode can be introduced for every color component, e.g., luma (Y) and both chromas (U and V). In this case IntraBLSkipY, IntraBLSkipU and IntraBLSkipV modes can be used.

In another embodiment, only two IntraBLSkip modes are used: one for luma and one for both chroma components. In yet another embodiment, only one IntraBLSkip mode is used for all color components together.

If IntraBLSkip mode is applied for all color components together, then it can be treated as a group of coded block flags (CBFs) or no_residual_data_flag, as discussed below.

Since IntraBLSkip mode assumes zero residual information (e.g., all coded block flags for all color components are zero), the redundancy of CBF coding for IntraBL mode can be eliminated. If IntraBLSkip mode is not chosen, then at least one coded block flag should be non-zero for IntraBL mode. Therefore, if the first two coded CBFs are zero, the signaling of the third coded block flag can be omitted and this third CBF is inferred to be non-zero at the decoder side. If all coded block flags are zero, IntraBL mode converts to IntraBLSkip mode.

Additionally, the third CBF inferring or derivation for IntraBL can be transform depth or CU depth dependent. For example, the third CBF may be determined to be non-zero only for a transform depth equal to zero if the other two CBFs are zero.

IntraBLSkip mode can be applied for PU/CU/LCU, group of CUs, slice or frame levels.

There are other modes where the prediction residual of a base layer block is used to predict the residual of a co-located enhancement layer block. For this mode, an analog of the skip mode (additional residual prediction skip mode) can be also introduced and all the methods described above for IntraBLSkip mode are applicable. For example, as described above, when implemented, there is no need to signal transform coefficients and transform depth. This new mode also can be indicated with an additional flag and be placed with different order relatively to already existing modes. This mode can be applied for all color components together or separately, and third CBF can be inferred or derived if first two CBFs are zero for non-skip version of the residual prediction mode. Additionally, new CABAC contexts can be introduced to code this residual prediction skip mode flag, or contexts can be shared with already existing contexts (e.g., with residual prediction mode).

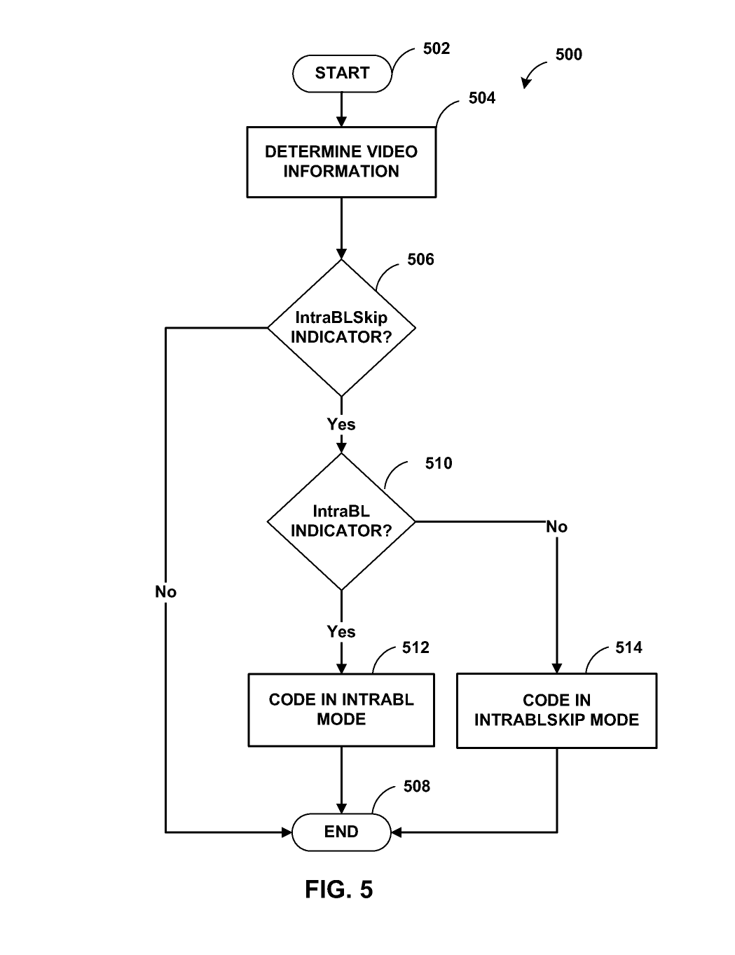

One embodiment of a method of coding video information according to these techniques is illustrated in FIG. 5. The method 500 begins at block 502. At block 504, video information is determined. For example, the video information may be received by an encoder, such as the encoder 20 of FIG. 2 or a decoder, such as the decoder 30 of FIG. 3, discussed above. At block 506, the method 500 determines whether an IntraBLSkip indicator is active. For example, the method 500 determines whether an IntraBLSkip flag is set. If not, the method 500 continues to block 508, where the method 500 ends. If an IntraBLSkip flag is set, the method 500 continues to block 510. At block 510, the method 500 determines whether an IntraBL indicator is set. For example, the method 500 determines whether an IntraBL flag is set. If yes, the method 500 continues to block 512; if not, the method 500 continues to block 514. At block 512 coding in IntraBL mode is performed. For example, encoding or decoding in IntraBL mode may be performed. At block 514, coding in IntraBLSkip mode is performed. For example, encoding or decoding in IntraBLSkip mode may be performed. For example, the encoding may be performed by the encoder 20 of FIG. 2 and the various elements included therein, such as the mode select unit 40, and the decoding may be performed by the decoder 30 of FIG. 3 and the various elements included therein such as the entropy decoding unit 70 and the motion compensation unit 72. Coding in IntraBLSkip mode may be performed, for example, according to the method described above and/or in connection with FIG. 4.

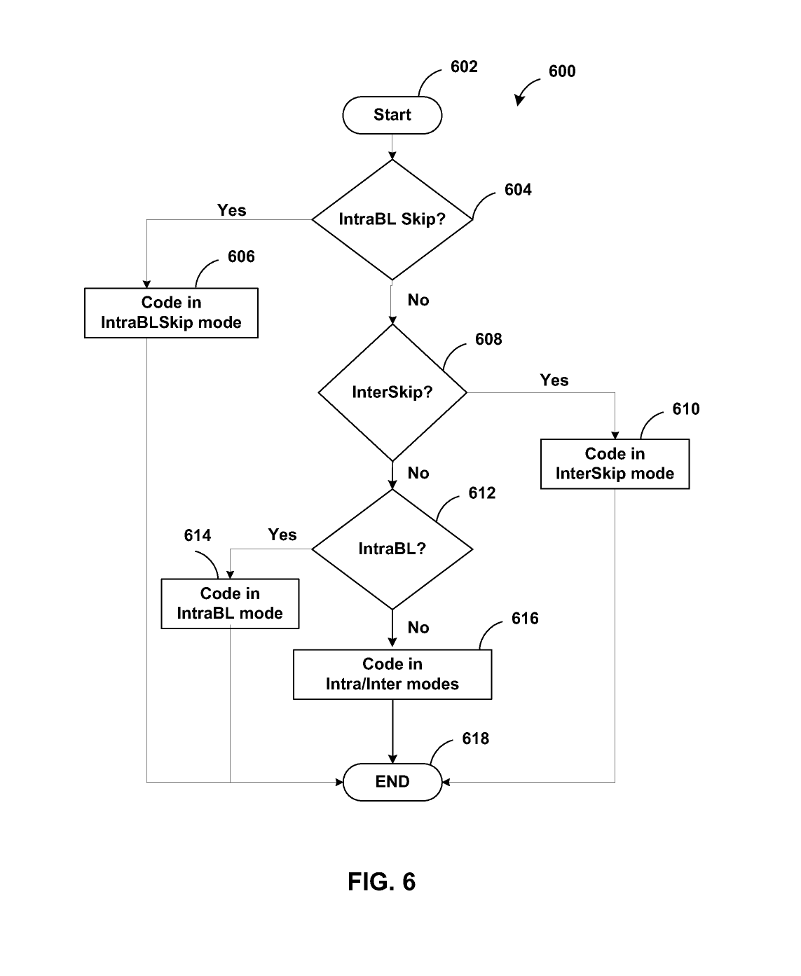

Another embodiment of a method of coding video information is illustrated in the flow chart of FIG. 6. The method 600 begins at block 602. At block 604, the method 600 determines whether an IntraBLSkip mode is signaled. If it is determined that an IntraBLSkip mode is signaled, the method 600 proceeds to block 606. If it is determined that an IntraBLSkip mode is not signaled, the method 600 continues to block 608. At block 606, the video information is coded according to the IntraBLSkip mode. The method 600 continues to block 618, where the method 600 ends.

At block 608, the method 600 determines whether an InterSkip mode is signaled. If it is determined that an InterSkip mode is signaled, the method 600 proceeds to block 610. If it is determined that an InterSkip mode is not signaled, the method continues to block 612. At block 610, the video information is coded according to the InterSkip mode. The method 600 continues to block 618, where the method 600 ends.

At block 612, the method 600 determines whether an IntraBL mode is signaled. If it is determined that an IntraBL mode is signaled, the method 600 proceeds to block 614. If it is determined that an IntraBL mode is not signaled, the method continues to block 616. At block 614, the video information is coded according to the IntraBL mode. The method 600 continues to block 618, where the method 600 ends.

At block 616, the video information is coded according to a standard Intra/Inter mode. The method 600 continues to block 618, where the method 600 ends.

The various determinations and coding of video information may be performed, for example, by the mode select unit 40 of FIG. 2 or the entropy decoding unit 70 of FIG. 3. However, performing of such steps is not limited to such units and may be carried out by another unit or a combination of units included in video encoders and/or decoders.

### No Residual Flag Extension

In one implementation, “no_residual_data_flag” in HEVC for Inter Prediction is extended to IntraBL mode. This flag may be used to indicate if the residual data is present for all the components or each of the components in the Coding Unit. When no_residual_data_flag is equal to 1, it specifies that no residual data are present for the current coding unit and there is no need to signal transform coefficients, depths or CBFs for the current coding unit. When no_residual_data_flag is equal to 0, it specifies that residual data are present for the current coding unit. When no_residual_data_flag is not present, its value is inferred to be equal to 0.

In accordance with one implementation, the current no_residual_data_flag coding syntax is extended with an additional condition as shown underlined (“∥ INTRABL_Mode”).

```
if( trafoDepth == 0 && IntraSplitFlag == 0 && PredMode
!= MODE_INTRA &&
  !(PartMode == PART_2Nx2N && merge_flag[x0][y0])
  ∥ INTRABL_Mode )
    no_residual_data_flag
```

New CABAC contexts can be introduced to code no_residual_data_flag separately for IntraBL Mode. For example if the mode is IntraBL then no_residual_data_flag can be coded using new context model. Alternatively the context model can be shared with already existing contexts. For example, if no_residual_data_flag for IntraBL mode can be coded with the same context as no_residual_data_flag of Inter Prediction.

Methods described herein can be also applied to MVC (multi-view coding) or 3DV extensions. In such cases, views can be used instead of base layers, as discussed above.

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Various embodiments of the invention have been described. These and other embodiments are within the scope of the following claims.

What is claimed is:

1. An apparatus configured to code video data, the apparatus comprising:
a memory unit configured to store the video data, the video data comprising a base layer and a corresponding enhancement layer; and
a processor in communication with the memory, the processor configured to determine an enhancement layer block in the enhancement layer of the video data based at least in part on a co-located block in the base layer of the video data while assuming a residual associated with the enhancement layer block is equal to zero and without transmitting or receiving at least one of transform coefficients, coded block flags and a transform depth associated with the enhancement layer block, in a case that the video data comprises a particular mode flag,
wherein the co-located block in the base layer is located at a position in the base layer corresponding to a position of the enhancement layer block in the enhancement layer.

2. The apparatus of claim 1, wherein the particular mode flag is a skip mode indicator associated with an IntraBL mode.

3. The apparatus of claim 1, wherein the particular mode flag is a no_residual_data_flag indicating whether the residual associated with the enhancement layer block is equal to zero.

4. The apparatus of claim 1, wherein the enhancement layer block in the enhancement layer is determined using reconstructed pixels of the co-located block in the base layer.

5. The apparatus of claim 1, wherein the particular mode flag comprises a single bit.

6. The apparatus of claim 1, wherein the particular mode flag comprises multiple bits.

7. The apparatus of claim 1, wherein the apparatus comprises an encoder.

8. The apparatus of claim 1, wherein the apparatus comprises a decoder.

9. The apparatus of claim 1, further comprising at least one of a desktop computer, a notebook computer, a tablet computer, a set-top box, a telephone handset, a television, a camera, a display device, a digital media player, a video gaming console and an in-car computer, that comprises the memory and the processor.

10. The apparatus of claim 1, wherein the processor is configured to determine the enhancement layer block by predicting the enhancement layer block.

11. The apparatus of claim 2, wherein the processor is configured to insert the skip mode associated with the IntraBL mode as a first signaled mode in a mode list associated with the enhancement layer block.

12. The apparatus of claim 2, wherein the skip mode associated with the IntraBL mode is signaled at at least one of a partition unit (PU) level, a coding unit (CU) level, a group of coding units level, a slice level, a frame level, a largest coding unit (LCU) level and a color component level.

13. The apparatus of claim 1, wherein the processor is further configured to determine the enhancement layer block based at least in part upon an IntraBL mode indicator.

14. The apparatus of claim 2, wherein the processor is further configured to first determine whether the video data comprises the skip mode indicator associated with the IntraBL mode and subsequently determine whether the video data comprises the IntraBL mode indicator.

15. The apparatus of claim 2, wherein the processor is further configured to first determine whether the video data comprises the IntraBL mode indicator and subsequently determine whether the video data comprises the skip mode indicator associated with the IntraBL mode.

16. The apparatus of claim 2, wherein the IntraBL mode indicator is coded with InterSkip mode indicator contexts.

17. The apparatus of claim 1, wherein the skip mode indicator associated with the IntraBL mode is coded with contexts solely related to the skip mode.

18. The apparatus of claim 1, wherein the skip mode indicator associated with the IntraBL mode is coded with IntraBL mode indicator contexts.

19. The apparatus of claim 1, wherein the skip mode indicator associated with the IntraBL mode is coded with InterSkip mode indicator contexts.

20. A method of encoding video data, the method comprising:
receiving information associated with a base layer and a corresponding enhancement layer of the video data;
determining, in a case that the video data comprises a particular mode flag, an enhancement layer block in the enhancement layer of the video data based at least in part on a co-located block in the base layer of the video data while assuming a residual associated with the enhancement layer block is equal to zero and without transmitting or receiving transform coefficients, coded block flags or a transform depth associated with the enhancement layer block, the co-located block in the base layer being located at a position in the base layer corresponding to a position of the enhancement layer block in the enhancement layer; and
signaling at least one syntax element associated with the enhancement layer block in a bitstream.

21. The method of claim 20, wherein the particular mode flag is a skip mode indicator associated with an IntraBL mode.

22. The method of claim 21, wherein the particular mode flag is a no_residual_data_flag indicating whether the residual associated with the enhancement layer block is equal to zero.

23. The method of claim 21, wherein the enhancement layer block in the enhancement layer is determined using reconstructed pixels of the co-located block in the base layer.

24. The method of claim 21, wherein the processor is configured to determine the enhancement layer block by predicting the enhancement layer block.

25. The method of claim 21, wherein the processor is configured to insert the skip mode associated with the IntraBL mode as a first signaled mode in a mode list associated with the enhancement layer block.

26. The method of claim 21, wherein the processor is further configured to determine the enhancement layer block based at least in part upon an IntraBL mode indicator.

27. The method of claim 21, wherein the processor is further configured to first determine whether the video data comprises the skip mode indicator associated with the IntraBL mode and subsequently determine whether the video data comprises the IntraBL mode indicator.

28. The method of claim 21, wherein the processor is further configured to first determine whether the video data comprises the IntraBL mode indicator and subsequently determine whether the video data comprises the skip mode indicator associated with the IntraBL mode.

29. A method of decoding video data, the method comprising:
receiving syntax elements extracted from an encoded video bitstream, wherein the syntax elements comprise information associated with a base layer and a corresponding enhancement layer of the video data; and
determining, in a case that the video data comprises a particular mode flag, an enhancement layer block in the enhancement layer of the video data based at least in part on a co-located block in the base layer of the video data while assuming a residual associated with the enhancement layer block is equal to zero and without transmitting or receiving transform coefficients, coded block flags or a transform depth associated with the enhancement layer block, the co-located block in the base layer being located at a position in the base layer corresponding to a position of the enhancement layer block in the enhancement layer.

30. The method of claim 29, wherein the particular mode flag is a skip mode indicator associated with an IntraBL mode.

31. The method of claim 29, wherein the particular mode flag is a no_residual_data_flag indicating whether the residual associated with the enhancement layer block is equal to zero.

32. The method of claim 29, wherein the enhancement layer block in the enhancement layer is determined using reconstructed pixels of the co-located block in the base layer.

33. The method of claim 29, wherein the processor is configured to determine the enhancement layer block by predicting the enhancement layer block.

34. The method of claim 30, wherein the processor is configured to insert the skip mode associated with the IntraBL mode as a first signaled mode in a mode list associated with the enhancement layer block.

35. The method of claim 29, wherein the processor is further configured to determine the enhancement layer block based at least in part upon an IntraBL mode indicator.

36. The method of claim 30, wherein the processor is further configured to first determine whether the video data comprises the skip mode indicator associated with the IntraBL mode and subsequently determine whether the video data comprises the IntraBL mode indicator.

37. The method of claim 30, wherein the processor is further configured to first determine whether the video data comprises the IntraBL mode indicator and subsequently determine whether the video data comprises the skip mode indicator associated with the IntraBL mode.

38. A non-transitory computer readable medium comprising code that, when executed, causes an apparatus to:
store video data comprising a base layer and a corresponding enhancement layer; and
determine an enhancement layer block in the enhancement layer of the video data based at least in part on a co-located block in the base layer of the video data while assuming a residual associated with the enhancement layer block is equal to zero and without transmitting or receiving transform coefficients, coded block flags or a transform depth associated with the enhancement layer block, in a case that the video data comprises a particular mode flag,
wherein the co-located block in the base layer is located at a position in the base layer corresponding to a position of the enhancement layer block in the enhancement layer.

39. The medium of claim 38, wherein the particular mode flag is a skip mode indicator associated with an IntraBL mode.

40. The medium of claim 38, wherein the particular mode flag is a no_residual_data_flag indicating whether the residual associated with the enhancement layer block is equal to zero.

41. The medium of claim 39, wherein the code, when executed, further causes the apparatus to insert the skip mode associated with the IntraBL mode as a first signaled mode in a mode list associated with the enhancement layer block.

42. The medium of claim 39, wherein the code, when executed, further causes the apparatus to first determine whether the video data comprises the skip mode indicator associated with the IntraBL mode and subsequently determine whether the video data comprises the IntraBL mode indicator.

43. The medium of claim 39, wherein the code, when executed, further causes the apparatus to first determine whether the video data comprises the IntraBL mode indicator and subsequently determine whether the video data comprises the skip mode indicator associated with the IntraBL mode.

44. A video coding device configured to code video data, the video coding device comprising:
means for storing the video data, the video data comprising a base layer and a corresponding enhancement layer; and
means for determining an enhancement layer block in the enhancement layer of the video data based at least in part on a co-located block in the base layer of the video data while assuming a residual associated with the enhancement layer block is equal to zero and without transmitting or receiving transform coefficients, coded block flags or a transform depth associated with the enhancement layer block, in a case that the video data comprises a particular mode flag,
wherein the co-located block in the base layer is located at a position in the base layer corresponding to a position of the enhancement layer block in the enhancement layer.

45. The device of claim 44, wherein the particular mode flag is a skip mode indicator associated with an IntraBL mode.

46. The device of claim 44, wherein the particular mode flag is a no_residual_data_flag indicating whether the residual associated with the enhancement layer block is equal to zero.

47. The device of claim 45, wherein the code, when executed, further causes the apparatus to insert the skip mode associated with the IntraBL mode as a first signaled mode in a mode list associated with the enhancement layer block.

48. The device of claim 45, wherein the code, when executed, further causes the apparatus to first determine whether the video data comprises the skip mode indicator associated with the IntraBL mode and subsequently determine whether the video data comprises the IntraBL mode indicator.

49. The device of claim 45, wherein the code, when executed, further causes the apparatus to first determine whether the video data comprises the IntraBL mode indicator and subsequently determine whether the video data comprises the skip mode indicator associated with the IntraBL mode.
